(19) United States
(12) Patent Application Publication
(10) Pub. No.: US 2005/0090566 A1
(43) Pub. Date: Apr. 28, 2005

(54) Synthetic resins in casein-stabilized rosin size emulsions

(76) Inventors: Alan F. Nitzman, Pensacola, FL (US); James D. Reeves, Pensacola, FL (US)

Correspondence Address: ROTHWELL, FIGG, ERNST & MANBECK, P.C., 1425 K STREET, N.W., SUITE 800, WASHINGTON, DC, 20005, US

(21) Appl. No.: 10/955,005

(22) Filed: Sep. 30, 2004

Related U.S. Application Data
(60) Provisional application No. 60/507,083, filed on Oct. 1, 2003.

(51) Int. Cl. B01F 3/08

(52) U.S. Cl. 516/75; 516/53; 516/72

(57) ABSTRACT

A process for forming a rosin-containing size emulsion for paper sizing, in which a basic aqueous first mixture containing at least partially saponified rosin is mixed with a basic aqueous dispersion of casein and formed into an oil-in-water emulsion, wherein an emulsion-stabilizing amount of a casein-compatible rosin-emulsifying synthetic resin is substituted for a portion of the casein, the portion being within a range of about 1-80% by weight of the casein.

### CROSS-REFERENCE TO RELATED APPLICATION

This application claims benefit of U.S. Provisional Application Ser. No. 60/507,083, filed Oct. 1, 2003.

### FIELD OF THE INVENTION

The invention relates to the field of rosins as sizing agents for paper products.

### BACKGROUND OF THE INVENTION

Paper has been sized using rosin and alum for about two hundred years now. For most of this time, rosin was mostly saponified, that is reacted with an alkali to render it partly or completely soluble in water. The rosin soap is then mixed with paper fibers, and alum, aluminum sulphate, to precipitate the rosin onto the fibers. Alternatively, rosin, not rosin soap, may be used. U.S. Pat. No. 1,882,680, issued in 1932, describes a dispersion of rosin. In this case, most of the rosin is not saponified, but is in the free acid form. Rosin in the free acid form is a better sizing agent than saponified rosin. U.S. Pat. No. 1,882,680 was important in that it describes a process that can be used to produce rosin dispersions useful for sizing by a practical and commercially economical process. The process by which this dispersion is prepared is often called the inversion process and also called the Bewoid process. The inversion process is an appropriate name because at first a water-in-oil emulsion is made, and then it is inverted to form an oil-in-water emulsion. The dispersion is stabilized by a combination of rosin soap, formed by reaction of a small fraction of the rosin and an alkali, and a protective colloid, casein being the primary example. Products can also be made by other processes known to the art, in particular by processes using a homogenizer.

Today, dispersed rosin sizes, also called rosin size emulsions, are very important commercial products, and most of these dispersions that are anionic in character, are still stabilized with rosin alkali soaps and casein. One problem, however, with casein-stabilized products is that casein has historically had a very volatile price.

### SUMMARY OF THE INVENTION

In accordance with the present invention, a method is disclosed for the production of paper wherein a sizing agent is mixed with an aqueous dispersion containing paper pulp, and the pulp is thereafter formed into paper. The invention utilizes an improved sizing agent comprising a rosin dispersion stabilized with a combination of an alkali, casein and a synthetic resin.

### DETAILED DESCRIPTION OF THE PREFERRED EMBODIMENTS

This invention relates to dispersions of rosin that are highly effective sizing agents for paper. The dispersions are anionic in charge, and are stabilized with an alkali and casein and selected synthetic resins. These dispersions are more stable and more effective compared to dispersed sizes made with alkali and casein.

Casein stabilized rosin size emulsions are typically made with formulations similar to that described by U.S. Pat. No. 1,882,680. Thus, these rosin dispersions contain rosin, water, an alkali and casein. Sometimes, a surfactant, such as an ethoxylated nonyl phenol surfactant, is added to help stabilize the emulsion. What we have found is that this basic formulation can be modified by incorporation of synthetic resins in place of part of the casein as a colloidal combination. Any synthetic resin will work which has compatibility with casein and enough surface-active functionality so that a rosin emulsion can be formed. Synthetic resins that have been found to work include styrene-acrylic resins, styrene-maleic anhydride resins and polyacrylamide resins. For example, the resin can be an anionic styrene-acrylic type polymer, a styrene-maleic anhydride type polymer, a cationic acrylamide type polymer, or mixture thereof. The quantity of the colloidal combination required is usually small, being for example within a range of about 1-10% by weight of the material to be dispersed, preferably about 2-8%, more preferably about 3.5-6% by weight. The resulting product still has the main attributes of casein stabilized rosin size emulsions, that is excellent emulsion properties and excellent long-term storage stability, and they are stable with respect to shearing conditions (shear stable). The resulting products have advantages over previous formulations of lower cost, better sizing performance and better emulsion stability. Furthermore, products containing synthetic resins not derived from starch provide more resistance to biological activity, and such products require smaller amounts of biocides to preserve them.

In addition to Rosin, the material to be dispersed may include one or more additional sizing agents such as alkylketene dimer (AKD) sizing agents, alkenyl succinic anhydride (ASA) sizing agents and combinations thereof.

Thus, the products can be rosin size emulsions, and combinations of rosin and ASA, and combinations of rosin and AKD, and combinations of rosin, ASA and AKD. The amounts of casein and synthetic resins may be varied within limits without changing the nature of the products. It is not necessary for the amount of synthetic resin to match exactly the amount of the casein taken out of the formulation.

Thus, the invention is applicable to a process for forming a rosin-containing size emulsion for paper sizing, in which a basic aqueous first mixture containing at least partially saponified rosin in mixed with a basic aqueous dispersion of casein and formed into an oil-in-water emulsion. In accordance with the present invention, the improvement comprises substituting an emulsion-stabilizing amount of a casein-compatible rosin-emulsifying synthetic resin for a portion of the casein, the portion being within a range of about 1-80% by weight of the casein.

In preferred embodiments, the rosin is softened by heating and subjected to agitation while combining the rosin with an aqueous solution of a base so as to at least partially saponify the rosin and form the first mixture.

In preferred embodiments, the casein dispersion is formed by dispersing the casein in water by raising the pH of the water by adding base to the water under agitation and heating.

In preferred embodiments, the casein dispersion is mixed with the first mixture to form a second mixture which is a water-in-oil first emulsion, and water is added to the second mixture so as to invert the first emulsion into the oil-in-water emulsion. In preferred embodiments, the oil-in-water emulsion is anionic.

In preferred embodiments, the synthetic resin is substituted for a portion of the casein, the portion being with a range of about 10-50% by weight of the casein, more preferably about 20-50% by weight of the casein, and most preferably about 25-50% by weight of the casein.

The invention also is applicable to anionic aqueous rosin-containing size emulsions comprising an oil-in-water emulsion containing rosin in an amount within a range of about 20-60% by weight of the composition, and a colloidal combination within a range of about 1-10% by weight. The colloidal combination comprises casein and an emulsion-stabilizing amount of a casein-compatible rosin-emulsifying synthetic resin as described herein. The synthetic resin comprises about 1-80% by weight of the colloidal combination, and the casein may comprise the remaining portion of the combination.

In preferred embodiments, the oil-in-water emulsion has a solids content within a range of about 20-60% by weight, more preferably in a range of about 30-50% by weight, still more preferably within a range of about 35-45% by weight, and most preferably about 40% by weight. As indicated above, the synthetic resin may be anionic or cationic.

When used as an internal size in the paper industry; products prepared by the present invention achieve useful increases in sizing with applications of about ¼th to about 30 lb/ton of furnish in unbleached grades of paper, and about 1 to 50 lb/ton for bleached grades of paper. Preferred ranges for products prepared by the methods of this patent are about ½ to 8 lb/ton for unbleached grades of paper and about 4 to 12 lb/ton for bleached grades of paper.

The invention is further illustrated by the following examples, which are not intended to be limiting.

### EXAMPLE 1

In this example, the preparation of a product is described which is presently known to the art. Rosin is placed in a round bottom flask fitted with a stirrer and heated well above its softening point. The agitator is started, and an aqueous solution of a base is added slowly to the flask. The base may be sodium hydroxide, potassium hydroxide, ammonium hydroxide, sodium borate or other such compounds and the amount of the base is sufficient to saponify a few percent of the rosin. Casein is dispersed in water by raising the pH with a base under agitation and heating. The casein dispersion is then slowly added to the rosin. Then, hot water is added to the mixture. Normally the mixture inverts during this water addition, that is, the emulsion inverts from a water-in-oil type to an oil-in-water form. Cold water is added until the final desired concentration is reached. Biocides and defoamers may be added as desired.

In the table below, the emulsion properties of a rosin dispersion prepared in this way are listed. This product was prepared with KOH as the base, 5.7% casein on rosin, and rosin consisting of a 9% fumaric acid adduct of tall oil rosin. Emulsion properties include total solids, fall out, viscosity, turbidity and pH. Fall out is the amount of sediment accumulated on the bottom of a centrifuge test after spinning a 50 g. sample at 1024 g forces for one half hour, pouring off the supernatant, rinsing the residue lightly with water and drying the residue at 105° C. for three hours. Fall out is the amount of residue, reported as a percentage of the dispersion solids. Viscosity measurements are from a Brookfield model DV-I+, using spindle LV 1. Turbidity is a measure of particle size with higher values indicating smaller particle sizes.

The amount of casein used may be varied from about 2% of the rosin to 6% or more. The shear stability and emulsion stability of the product varies with amount of casein used. For truly excellent shear stability about 5% or more casein on rosin is required.

The inversion process can also be conducted in a batch process, as outlined in example 1, or by a continuous process. Using a continuous inversion process, contact times are much shorter than in the batch process, but the products are essentially the same. The same basic formulation may also be processed by other methods, such as homogenization, either with or without a solvent.

The rosin may be Tall Oil Rosin, gum rosin, wood rosin and mixtures of these types. Partially or substantially hydrogenated rosins and polymerized rosins may also be used, as well as rosins that have been treated to inhibit crystallization such as by heat treatment or reaction with formaldehyde. Fortified rosin or esterified rosin or fortified and esterified rosin or mixtures of fortified and esterified rosins may also be used. By fortified rosin we mean rosin that has been reacted with fumaric acid or maleic anhydride or other dienophiles to increase the number of carboxylic acid groups. The level of fortification possible varies over a wide range, from very low levels approaching nil, to 15% of the fortifying agent compared to the rosin and even greater. Rosin esters may be prepared according to U.S. Pat. No. 5,399,660, U.S. Pat. No. 4,842,691, U.S. Pat. No. 4,540,635 or other methods.

### EXAMPLE 2

This example illustrates replacement of part of the casein with a styrene-acrylic resin. The rosin is melted and saponified to a few percent as in example 1. Aqueous casein dispersion is prepared as in example 1 except the quantities of casein, water and base are reduced by 40%. Separately an aqueous solution of a styrene-acrylic resin is prepared by stirring the resin in warm water and adding enough base to raise the pH until the resin dissolves. The weight of the styrene-acrylic resin is equal to the amount the casein was reduced. The base used is preferably, but not necessarily, the same as used to disperse the casein. The casein dispersion is combined with the solution of styrene-acrylic resin, and the mixture is then added to the rosin emulsion, followed by the hot water and cold water additions. The styrene-acrylic resin used is KN-500 available commercially from Plasmine Technology, Inc. This resin is anionic.

### EXAMPLE 3

This example illustrates a different level of replacement of casein with a styrene-acrylic resin. Product was prepared as in example 2 except that the amount of casein was reduced by 19% instead of 40% reduction. The amount of styrene-acrylic resin was equal to the amount of casein removed. The styrene-acrylic resin was the same as in example 2. Emulsion properties are given in Table 1.

TABLE 1

| | Example | | | | |
|---|---|---|---|---|---|
| | 1 | 2 | 3 | 4 | 5 |
| Total Solids, % | 39.7 | 39.7 | 39.0 | 40.0 | 40.1 |
| Fall Out, % | 1.1 | 2.5 | 0.7 | 0.8 | 22 |
| Viscosity, cp | 6.6 | 3.4 | 11.9 | 11.0 | 5.0 |
| Turbidity at 10 ppm, | 30.8 | 25.6 | 30.1 | 31.4 | 19.7 |
| NTU | | | | | |
| pH | 6.0 | 6.2 | 6.1 | 6.2 | 6.2 |
| Casein | None | 40 | 19 | 29 | 48 |
| Reduction, % | | | | | |

### EXAMPLE 4

This example illustrates a different level of replacement of casein with a styrene-acrylic resin. Product was prepared as in example 2 except that the amount of casein was reduced by 29% instead of 40% reduction. The amount of styrene-acrylic resin was equal to the amount of casein removed. The styrene-acrylic resin was the same as in example 2. Emulsion properties are given in Table 1.

### EXAMPLE 5

This example illustrates a different level of replacement of casein with a styrene-acrylic resin. Product was prepared as in example 2 except that the amount of casein was reduced by 48% instead of 40% reduction. The amount of styrene-acrylic resin was equal to the amount of casein removed. The styrene-acrylic resin was the same as in example 2. Emulsion properties are given in Table 1.

Emulsion properties in Table 1 reveal trends noted when casein is replaced with a substitute resin. Fall out is a measure of the amount of over-sized particles, particles large enough to “fall out” of suspension to the bottom of a jar or storage tank. Smaller fall out values indicate less waste material and less need to clean filters, storage tanks and pipe lines. The trends in Table 1 indicate that replacement of some of the casein with a suitable styrene-acrylic resin improves fall out values. The data also indicate that too high a replacement amount causes emulsion properties to deteriorate. Fall out in example 5 is 22%, and this product would be impractical to use in paper mills due to severe problems such as sludge buildup in storage tanks and frequent cleaning of filters and pipelines. The decision as to what fall out values are acceptable is somewhat arbitrary, but clearly levels below 5% are practical in industrial use conditions.

### EXAMPLE 6

This example illustrates replacement of part of the casein with a polyacrylamide resin. Product was prepared as in example 2 except that the synthetic resin was a polyacrylamide instead of a styrene-acrylic resin. The polyacrylamide resin was Nalsize 7541 from Ondeo Nalco Co. This resin is mildly cationic. Combining the polyacrylamide resin and casein forms a stable mixture even though at the pH values used casein is anionic. Since the charges are different, the casein-polyacrylamide mixture in water can be called a coacervate. Emulsion properties are given in Table 2.

### EXAMPLE 7

This example illustrates a different level of replacement of casein with a polyacrylamide resin. Product was prepared as in example 6 except that the amount of casein was reduced by 29% instead of 40% reduction. The amount of polyacrylamide resin was equal to the amount of casein removed. The polyacrylamide resin was the same as in example 6. Emulsion properties are given in Table 2.

### EXAMPLE 8

This example illustrates replacement of part of the casein with a styrene-maleic anhydride (SMA) resin. Product was prepared as in example 2 except that the synthetic resin was a styrene-maleic anhydride instead of a styrene-acrylic resin. The styrene-maleic anhydride resin was SMA 3000 H from Sartomer Company, Inc. This resin is anionic. Emulsion properties are given in Table 2.

### EXAMPLE 9

This example illustrates a different level of replacement of casein with an SMA resin. Product was prepared as in example 8 except that the amount of casein was reduced by 30% instead of 20% reduction. The amount of SMA resin was equal to the amount of casein removed. The SMA resin was the same as in example 6. Emulsion properties are given in Table 2.

TABLE 2

| | Example | | | |
|---|---|---|---|---|
| | 6 | 7 | 8 | 9 |
| Resin | polyacrylamide | polyacrylamide | SMA | SMA |
| Total Solids, % | 40.4 | 40.4 | 40.4 | 40.5 |
| Fall Out, % | 2.7 | 2.2 | 3.3 | 24 |
| Viscosity, cp | 33.8 | 26.5 | 23.0 | 11.5 |
| Turbidity at 10 ppm, | 18.5 | 20.1 | 23.3 | 20.8 |
| NTU | | | | |
| pH | 6.1 | 6.1 | 6.0 | 6.0 |
| Casein | 40 | 29 | 20 | 30 |
| Reduction, % | | | | |

Emulsion properties in Table 2 show that when casein is replaced with substitute resins, that good fall out values can be obtained and other properties are acceptable. The fall out values for examples 6, 7, and 8 are acceptable. Example 9, however, exhibits a fall out value that is too high as explained earlier, and this suggests that the upper limit of the incorporation of this particular SMA resin into the product had been exceeded.

Casein is an amphoteric material, and has an isoelectric point at pH 4.6 as discussed in Mark, Herman F., et al., ed., “Kirk-Othmer Encyclopedia of Chemical Technology”, p.861, John Wiley & Sons, Inc. New York, 1978. However, at the pH levels of useful rosin size products employing casein, casein is anionic. Resins in examples 2 through 5 are styrene-acrylic acid polymers and resins in example 8 and 9 are styrene-maleic anhydride polymers. These have anionic ionicity character. The polyacrylamide resins of examples 6 and 7 are cationic, however. All example resins form stable dispersions with casein, and this is interpreted to mean that it is a necessary characteristic for any resin to replace a significant part of the casein while maintaining excellent emulsion properties. That is, a synthetic resin may be cationic or anionic, but it must be compatible with casein in aqueous dispersions to be able to replace part of the casein. Clearly a synthetic resin may also be nonionic and be able to replace part of the casein.

Fall out is an indication of ability to store product without problems with sedimentation. However, agglomeration may occur over time and therefore storage stability can only be proven by actually retaining samples for extended periods of time. Samples of examples 1 through 9 were stored for three months at room temperature in 500 ml bottles. The height of the sample material was about 125 mm in each bottle. Samples of examples 1, 2, 3, 4, 6, 7 and 8 showed a small layer of sediment, less than 2 mm, after three months storage. Therefore, in this case, examples with good fall out values also exhibited good storage stability.

### EXAMPLE 10

This example shows the advantage of the preferred formulation over the usual formulation for sizing of paper. Hand sheets were prepared for testing of sizing. Procedures used generally conform to Tappi test method T 205 with the following exceptions: water was maintained at 45° C., sheets were pressed once for one minute at 60 psig, and drying was preformed in a laboratory drum drier for four minutes at approximately 120° C. The pH was adjusted with dilute sodium hydroxide within seconds of start of the disintegration step. Alum was added at the one-minute mark, and size at 1.5 minutes. At 2.5 minutes, the sheet was formed. 15 lb/ton of alum was used. The alum basis is defined according to the common practice in the paper industry as “dry” alum, actually with an average of 14 waters of hydration, Al₂(SO₄)₃.14H₂O. Pulp was a 50:50 mixture of bleached hardwood and softwood. A Canadian Standard Freeness (CSF) of 350 ml was measured. The results are shown in Table 3. Studied were sizes prepared according to example 1 and example 4. Sizing was analyzed according to the Hercules Sizing Test (HST), using 1% formic acid ink at 80% reflectance. The data show that example 4 was more efficient than example 1.

TABLE 3

Size

| | Size Level, lb/ton | HST, sec. |
|---|---|---|
| Example 1 | 4 | 107 |
| Example 4 | 4 | 124 |
| Example 1 | 7 | 436 |
| Example 4 | 7 | 516 |

### EXAMPLE 11

This example shows sizing data for other formulations of this invention. Hand sheets were prepared according to the procedures on example 10 except for the following differences. The temperature of the sheet during formation was 50° C. The pH of the final materials in the hand sheet mold was 5.5, and the amount of alum used was 14 lb/ton. Again the pulp was a 50:50 mixture of bleached hard wood and bleached soft wood and the CSF was 350 ml. The ink used in the HST contained 10% formic acid instead of 1%. Results are shown in Table 5. The data show that the sizing efficiency of examples 6 and 7 are greater than that of example 4. This suggests that the sizing efficiency of examples 6 and 7 should also be greater than example 1.

TABLE 4

Size

| | Size Level, lb/ton | HST, sec. |
|---|---|---|
| Example 4 | 6 | 68 |
| Example 6 | 6 | 103 |
| Example 7 | 6 | 84 |
| Example 4 | 9 | 180 |
| Example 6 | 9 | 217 |
| Example 7 | 9 | 203 |

### EXAMPLE 12

This example shows sizing data for other formulations of this invention. Hand sheets were prepared according to the procedures on example 10 except for the following differences. The pH of the final materials in the hand sheet mold was 5.0, and the amount of alum used was 10 lb/ton. Again the pulp was a 50:50 mixture of bleached hard wood and bleached soft wood. The CSF of the hard wood was measured to be 360 ml, and the soft wood measured 340 ml. Results are shown in Table 5. The data show that the sizing efficiency of example 1 and example 8 are similar at the lower dosage, but example 1 is better at the higher dosage. Example 9 is clearly less efficient than examples 1 and 8. This suggests that under the preparation conditions that SMA may be used as an acceptable replacement for casein at levels of about 20% and lower.

TABLE 5

Size

| | Size Level, lb/ton | HST, sec. |
|---|---|---|
| Example 1 | 3 | 162 |
| Example 8 | 3 | 164 |
| Example 9 | 3 | 78 |
| Example 1 | 5 | 595 |
| Example 8 | 5 | 481 |
| Example 9 | 5 | 278 |

### EXAMPLE 13

This example demonstrates the effect of substituting synthetic resins on shear stability. Shear stability data were obtained using a Maron Tester, which is based on the work of Maron, Maron, S. H., Anal. Chem., 25, 1087 (1953). The Maron Tester generates high shear stress by a stirring plate. This stirring plate is run with constant load and speed, and this produces a deposit from the sample. Shear stability information is calculated from the amount of deposit compared to the total solids of the sample. Products having good shear stability form smaller deposits. The Maron Tester used was manufactured by Kumagaya Rika, Tokyo, Japan. Model number is 2312. Results are given in Table 6 below. These results show that example 1 has a very low Maron number, indicating excellent shear stability. Example 4 is higher, but the number is still low enough to be considered indicative of excellent shear stability. For comparison, we have shown Maron stability data of two similar commercial products having similar compositions to example 1. The commercial products do not exhibit quite as good Maron shear stability, but are successful commercial products. NeuRoz 540 is manufactured by Plasmine Technology, Inc. and Neuphor 635 is manufactured by Hercules Incorporated.

TABLE 6

| Product | Maron Stability, % |
|---|---|
| Example 1 | 0.05 |
| Example 4 | 0.16 |
| NeuRoz 540 | 0.18 |
| Neuphor 635 | 0.39 |

1. In a process for forming a rosin-containing size emulsion for paper sizing, in which a basic aqueous first mixture containing at least partially saponified rosin is mixed with a basic aqueous dispersion containing casein and formed into an oil-in-water emulsion, the improvement comprising:
substituting, for a portion of the casein, an emulsion-stabilizing amount of a casein-compatible rosin-emulsifying synthetic resin, said portion being within a range of about 1-80% by weight of the casein.

2. The process of claim 1 wherein the rosin is softened by heating and subjected to agitation while combining the rosin within an aqueous solution of a base, so as to at least partially saponify the rosin and form said first mixture.

3. The process of claim 2 wherein the casein dispersion is formed by dispersing the casein in water by raising the pH of the water by adding base to the water under agitation and heating.

4. The process of claim 3 wherein the casein dispersion is mixed with the first mixture to form a second mixture which is a water-in-oil first emulsion, and water is added to the second mixture so as to invert the first emulsion into said oil-in-water emulsion.

5. The process of claim 1 wherein said oil-in-water emulsion is anionic.

6. The process of claim 1 wherein said range is about 10-50% by weight.

7. The process of claim 1 wherein said range is about 20-50% by weight.

8. The process of claim 1 wherein said range is about 25-50% by weight.

9. The process of claim 1 wherein said oil-in-water emulsion has a solids content within a range of about 20-60% by weight.

10. The process of claim 1 wherein said oil-in-water emulsion has a solids content within a range of about 30-50% by weight.

11. The process of claim 1 wherein said oil-in-water emulsion has a solids content within a range of about 35-40% by weight.

12. The process of claim 1 wherein said oil-in-water emulsion has a solids content of about 40% by weight.

13. The process of claim 1 wherein said synthetic resin is anionic.

14. The process of claim 1 wherein said synthetic resin is cationic.

15. The process of claim 1 wherein said synthetic resin is a styrene-acrylic resin.

16. The process of claim 1 wherein said synthetic resin is styrene-maleic anhydride resin.

17. The process of claim 1 wherein the synthetic resin is a cationic acrylamide resin.

18. The process of claim 1 wherein the synthetic resin is a polyacrylamide resin.

19. The process of claim 1 wherein said oil-in-water emulsion further comprises at least one of a further sizing agent selected from the group consisting of alkylketene dimer and alkenyl succinic anhydride.

20. A rosin-containing size emulsion prepared by the process of claim 1.

21. An anionic aqueous rosin-containing size emulsion comprising an oil-in-water emulsion containing rosin in an amount within a range of about 20-60% by weight, and a colloidal combination within a range of about 1-10% by weight, the colloidal combination comprising casein and an emulsion-stabilizing amount of a casein-compatible rosin-emulsifying synthetic resin, the synthetic resin comprising about 1-80% by weight of the combination, and the casein comprising a remaining portion of the combination.
